(19) United States
(12) Patent Application Publication
(10) Pub. No.: US 2026/0074122 A1
(43) Pub. Date: Mar. 12, 2026

(54) ELECTRET

(71) Applicants: DENSO CORPORATION, Kariya-city (JP); TOKYO UNIVERSITY OF SCIENCE FOUNDATION, Tokyo (JP)

(72) Inventors: Takuya IGASHIRA, Kariya-city (JP); Noriyuki MATSUSHITA, Kariya-city (JP); Kazuhiko KANO, Kariya-city (JP); Yumi TANAKA, Tokyo (JP); Kotaro MATSUMOTO, Tokyo (JP)

(21) Appl. No.: 19/394,265

(22) Filed: Nov. 19, 2025

Related U.S. Application Data
(63) Continuation of application No. PCT/JP2024/026339, filed on Jul. 23, 2024.

(30) Foreign Application Priority Data
Jul. 24, 2023 (JP) 2023-119798

(51) Int. Cl. H01G 7/02

(52) U.S. Cl. CPC H01G 7/026

(57) ABSTRACT

An electret is made by subjecting a composite oxide containing two or more metal elements to a polarization treatment. The composite oxide is a crystalline or non-crystalline oxide containing two different trivalent metal elements A and B, and has a basic composition represented by composition formula A₃B₅O₁₂. The composite oxide has a band gap energy of 3 eV or more. The metal element A includes at least one element selected from trivalent rare earth elements, and the metal element B includes at least one element selected from trivalent typical elements.

### CROSS REFERENCE TO RELATED APPLICATION

The present application is a continuation application of International Patent Application No. PCT/JP2024/026339 filed on Jul. 23, 2024, which designated the U.S. and claims the benefit of priority from Japanese Patent Application No. 2023-119798 filed on Jul. 24, 2023. The entire disclosures of all of the above applications are incorporated herein by reference.

### TECHNICAL FIELD

The present disclosure relates to an electret.

### BACKGROUND

An electret is an electrically charged material that provides an electrostatic field to the surroundings. The electret has been used in applications such as electret condenser microphones and dust-collecting filters.

### SUMMARY

According to an aspect of the present disclosure, an electret is obtained by subjecting a composite oxide containing two or more metal elements to a polarization treatment. The composite oxide contains two different trivalent metal elements A and B, and is a crystalline or non-crystalline oxide having a basic composition represented by the composition formula A₃B₅O₁₂. The composite oxide has a band gap energy of 3 eV or more.

### BRIEF DESCRIPTION OF DRAWINGS

The above and other objectives, features and advantages of the present disclosure will become more apparent from the following detailed description with reference to the accompanying drawings. In the drawings:

FIG. 1 is a schematic diagram for explaining a schematic configuration of an electret and an example of a polarization method in a first embodiment;

FIG. 2 is a schematic diagram showing a schematic configuration of an electret in a second embodiment;

FIG. 3 is a diagram showing a relationship between a heat treatment and a surface potential of electret in Examples and Comparative Example;

FIG. 4 is a graph showing a relationship between Mg substitution and a surface potential in Examples;

FIG. 5 is a diagram showing a relationship between a heat treatment and a surface potential of electret in Example and Comparative Example;

FIG. 6 is a diagram showing a relationship between a form and a surface potential of electret in Examples; and

FIG. 7 is a diagram showing a relationship between Mg substitution and a crystal structure of electret in Examples.

### DETAILED DESCRIPTION

An electret is an electrically charged material that provides an electrostatic field to the surroundings. The electret has been used in applications such as electret condenser microphones and dust-collecting filters. Moreover, in recent years, electrets have been attracting attention for applications to vibration power generation, which is one of the energy harvesting technologies. For example, the practical application of a small vibration energy harvesting device using electrets is highly anticipated, as a device, in which an integrated circuit is embedded, used in electrostatic vibration energy harvesters driven by environmental vibrations.

The electret is generally formed of an organic polymer material such as a fluorine-based resin. Organic polymer materials offer advantages in shape flexibility and thickness controllability in thin layer formation. However, organic polymer materials raise concerns about the thermal stability of the surface potential and temporal performance degradation. Thus, inorganic compound materials, which are superior in the thermal stability to organic polymer materials, are being examined for application in electrets. As an example of an inorganic compound material, an electret using a bulk sintered body of hydroxyapatite has been proposed, and it is believed that a high surface potential is generated due to defects in hydroxide ions caused by the sintering and dehydration treatment.

There is an electret using a complex oxide of a specific composition having an ABO₃ type perovskite structure containing two different metal elements A and B. In the composite oxide to be the electret, at least one of the metal elements A and B is partially substituted with a dopant element having a lower valence, thereby introducing oxygen vacancies, and this has the advantage that the amount of oxygen vacancies can be controlled by the amount of substitution.

It has been thought that for electrets using composite oxides with a perovskite structure, the decrease in surface potential after conversion to an electret can be suppressed by carrying out polarization treatment at a high temperature appropriate to the usage environment. However, it has been found that although the electret exhibits a stable surface potential in a temperature environment up to about 100° C., the surface potential of the electret is significantly reduced at temperatures exceeding 100° C. (for example, 200° C. or higher). On the other hand, when applying electrets to devices such as vibration power generation elements, the manufacturing process includes a heat treatment step and the devices are expected to be used in high-temperature environments, so there is a demand for electrets with higher thermal stability.

The present disclosure provides an electret that can maintain a high surface potential even in a high-temperature environment and has excellent thermal stability.

According to an aspect of the present disclosure, an electret is obtained by subjecting a composite oxide containing two or more metal elements to a polarization treatment. The composite oxide contains two different trivalent metal elements A and B, and is a crystalline or non-crystalline oxide having a basic composition represented by the composition formula A₃B₅O₁₂. The composite oxide has a band gap energy of 3 eV or more.

The electret of this aspect is composed of an oxide having a basic composition in which A:B:O in the composition formula A₃B₅O₁₂ is 3:5:12. It has been found that the electret is possible to maintain the surface potential generated by polarization even in a high-temperature environment of, for example, 200° C., and to suppress a decrease in the value of the surface potential. The reason for this is not entirely clear, but since a similar effect is not observed in oxides with an ABO₃ type perovskite composition containing the same metal elements, it is speculated that the higher proportion of metal elements in the B site compared to the A site has some contribution to thermal stability.

As described above, according to the above-mentioned aspect, it is possible to provide an electret that can maintain a high surface potential even in a high-temperature environment and has excellent thermal stability.

### First Embodiment

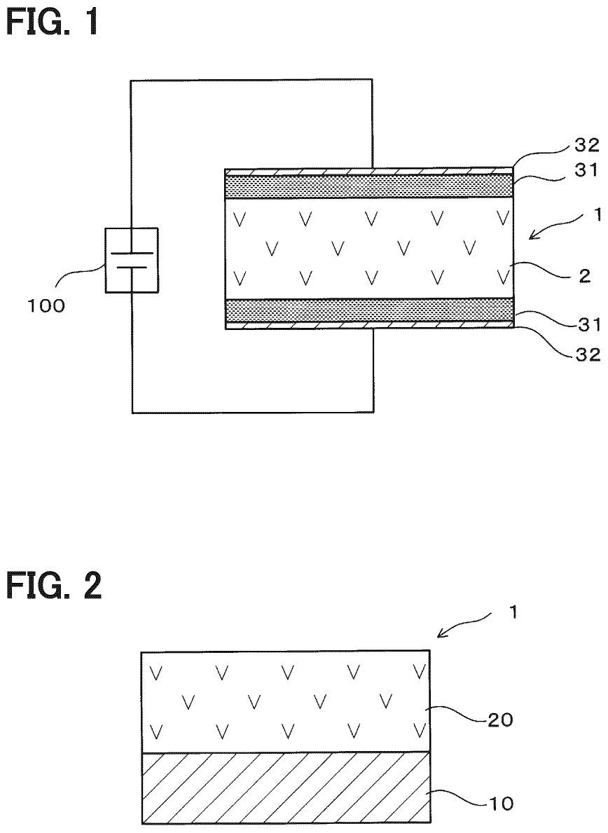

An electret according to a first embodiment will be described with reference to FIG. 1. As shown in FIG. 1, the electret 1 of this embodiment is formed by subjecting a composite oxide containing two or more kinds of metal elements to a polarization treatment. The composite oxide is configured as a pellet-shaped polycrystalline body 2. The composite oxide is a crystalline or non-crystalline oxide containing two different trivalent metal elements A and B and having a basic composition represented by the composition formula A₃B₅O₁₂. The composite oxide has a band gap energy of 3 eV or more, and therefore, when subjected to polarization treatment, develops a high surface potential.

The electret 1 is an electrically charged material that holds a positive or negative charge on its surface and provides an electrostatic field to its surroundings, and is capable of exhibiting electret performance by being subjected to a polarization treatment. As shown in the figure, the polarization treatment can be performed, for example, by sandwiching the polycrystalline body 2 between a pair of insulating sheets 31 having an Au film 32 on the outer surface, connecting the Au film 32 to a DC power source 100, and applying a predetermined high voltage at high temperature.

The treatment method for producing the electret is not limited to the method using a polarization treatment device as shown in the figure, and for example, a treatment method using corona discharge can also be adopted. The electret 1 obtained in this manner can be used as power generation element, in which an integrated circuit is embedded, in various devices that convert mechanical energy into electrical energy and vice versa, such as a small electrostatic vibration power generation device that uses ambient vibration as a power source.

In the composition formula A₃B₅O₁₂ of the composite oxide, the metal element A includes at least one element selected from trivalent rare earth elements, and the metal element B includes at least one element selected from trivalent typical elements. Specifically, the metal element A can be selected from at least one element selected from La, Y, Sm, and Gd. As the metal element A, two or more rare earth elements may be used in combination. The metal element B can be at least one element selected from Al and Ga, and Al and Ga can also be used in combination.

As will be described in detail later, in the composition formula A₃B₅O₁₂, at least one of the metal elements A or B may be substituted with a dopant element D having a lower valence than the metal element A, B. Specifically, one or both of the trivalent metal elements A and B can be partially substituted with a divalent dopant element D, for example.

Here, it is sufficient that the composite oxide has a basic composition represented by the composition formula A₃B₅O₁₂, and the ratio A:B:O of the basic constituent metal elements A, B and O is approximately 3:5:12 for the composite oxide as a whole. For example, even when the A site or the B site is substituted with a dopant element D, the content ratio of the metal elements occupying the A site or the B site may be configured to have a relationship of A:B:O=3:5:12 or a relationship close to this. In this case, the oxide does not need to have a uniform composition as a whole, and may have a composition partially different from the basic composition.

In general, the composition formula of a composite oxide is expressed as A₃B₅O_{12-δ}, taking into consideration the amount of oxygen vacancy o that occurs when sintering a powder raw material, for example. However, for simplicity, the amount of oxygen vacancy δ is omitted here. Furthermore, when the trivalent metal element A, B is replaced by a dopant element D having a lower valence, oxygen vacancies occur according to the amount of replacement. In this case, too, the basic composition before replacement is represented by the composition formula A₃B₅O₁₂.

The form of the electret 1 is not necessarily limited, and may be a crystalline oxide or a non-crystalline oxide. Here, for example, the powder raw material can be formed into a desired pellet shape and sintered to form the polycrystalline body 2. The shape of the polycrystalline body 2 is not particularly limited, but may be any shape such as a predetermined rectangular plate or disk shape. Furthermore, as the crystalline oxide, a single crystal having a desired shape can also be used. When a non-crystalline oxide is used, it can be configured as an amorphous thin film.

When the composite oxide is a crystalline oxide, it is preferable that the composite oxide mainly has a garnet-type crystal structure represented by the composition formula A₃B₅O₁₂. For example, when the composite oxide is a polycrystalline body 2, it is not necessary for all of the constituent particles to be made of garnet-type oxide crystals, and may have partially different compositions. However, it is believed that an increase in the amount of garnet-type oxide crystals will further improve the electret performance.

In the composition formula A₃B₅O₁₂, when at least one of the metal elements A or B is substituted, the substitution amount X by the dopant element D is preferably 60 atm % or less when the total of the metal elements A and B is 100 atm %. It has been found that when the substitution amount X by the dopant element D increases, for example, a crystal structure other than the garnet type is observed in part of the oxide crystals constituting the polycrystalline body 2. Therefore, from the viewpoint of mainly forming a garnet-type crystal, it is preferable to appropriately set the substitution amount X of the dopant element D within a range in which the substitution ratio of the metal element A, B to the whole does not exceed 60 atm %.

By introducing a dopant element D having a lower valence than the metal element A, B, oxygen defects corresponding to the substitution amount X are introduced into the crystal structure. It is believed that the larger the substitution amount X, the more easily oxygen defects are introduced, which contributes to the development of a surface potential. On the other hand, it is presumed that when the substitution amount X becomes large, the crystal grains constituting the polycrystalline body 2 become less likely to maintain the garnet-type crystal structure represented by the composition formula A₃B₅O₁₂, and tend to partially become crystals having a spinel-type (AB₂O₄) or perovskite-type (ABO₃) composition.

In the composition formula A₃B₅O₁₂, the metal elements A and B can be partially substituted with a first dopant element D1 and a second dopant element D2, respectively. When a part of the metal element A is replaced by a first dopant element D1 having a lower valence than the metal element A, the substitution amount X1 of the metal element A by the first dopant element D1 is preferably in the range of 0 atm %<X1≤60 atm %.

The first dopant element may be at least one element selected from the alkaline earth metal elements. Examples of the alkaline earth metal elements include Mg, Ca, Sr, Ba, and Zn. The substitution amount X1 can be appropriately set according to the desired electret performance so that the total substitution amount X of the metal elements A and B taking into consideration the substitution with the second dopant element D2 falls within the above range. The substitution amount X1 is preferably in the range of 0 atm %<X1≤40 atm %, and more preferably in the range of 0 atm %<X1≤20 atm %.

Even when a part of the metal element B is substituted by a second dopant element D2 having a lower valence than the metal element B, the substitution amount X2 of the metal element B by the second dopant element D2 is preferably in the range of 0 atm %<X2≤60 atm %. The second dopant element may be at least one element selected from alkaline earth metal elements and Zn. Examples of the alkaline earth metal elements include Mg, Ca, Sr, Ba, and Zn.

The substitution amount X2 of the second dopant element D2 can also be appropriately set in consideration of the substitution by the first dopant element D1 so that the total substitution amount X of the metal elements A and B falls within the above range. In this case as well, the substitution amount X2 is preferably in the range of 0 atm %<X2≤40 atm %, and more preferably in the range of 0 atm %<X2≤20 atm %.

Due to the polycrystalline body 2 having such a basic composition, a complex oxide material having a relatively large band gap energy of 3 eV or more can be obtained by appropriately selecting the metal element A, the metal element B, the first dopant element D1 and the second dopant element D2. This increases the dielectric breakdown voltage, making it possible to apply a high voltage during polarization treatment and develop a desired high surface potential. In addition, by changing the types of the first dopant element D1 and the second dopant element D2 for the metal elements A and B and adjusting the substitution amount X, the basic composition of the polycrystalline body 2 and the amount of oxygen vacancies introduced can be controlled to obtain an electret 1 with the desired electret performance.

### Second Embodiment

An electret according to a second embodiment will be described with reference to FIG. 2. Reference numerals used in the second and subsequent embodiments which are the same as those used in the previous embodiment denote the same components as in the previous embodiments unless otherwise indicated.

As shown in FIG. 2, the electret 1 of this embodiment is made of a non-crystalline thin film, and specifically, can be configured as an amorphous film 20 formed on the surface of a substrate 10. The amorphous film 20, like the polycrystalline body 2 in the first embodiment, is made of a complex oxide having a basic composition represented by the composition formula A₃B₅O₁₂ and a band gap energy of 3 eV or more, and is made into an electret by being subjected to a polarization treatment.

In this embodiment as well, the ratio A:B:O of the metal elements A and B, and O, which are basic constituent elements, may be approximately 3:5:12 in the overall composite oxide. In the basic composition of the amorphous film 20, the metal elements A and B can be selected in the same manner as in the first embodiment, and a portion of the metal elements A and B may be replaced by the first dopant element D1 and the second dopant element D2, respectively. In this case, the substitution amount X1, X2, etc. can be selected in the same manner as in the first embodiment.

The method for forming the amorphous film 20 is not necessarily limited, but for example, a sputtering method can be used. In this case, a polycrystalline composite oxide having a desired composition is prepared in advance, and sputtering is carried out in an inert gas using this as a target. This allows the amorphous film 20 to be formed with a thickness of 0.1 mm (100 μm) or less, and preferably has a desired thickness in the range of about 0.01 μm to several tens of μm.

The amorphous film 20 thus formed has the same basic composition as the target polycrystalline body. The film formation method is not limited to sputtering, and any method can be used. Other methods include physical vapor deposition, chemical vapor deposition, sol-gel method, and deposition, and may be appropriately selected taking into consideration the film quality and thickness to be formed.

The composition of the substrate 10 is not particularly limited, and for example, a conductive substrate made of (Nb, Sr)TiO₃, Si, or the like can be used. In addition, a conductive substrate using a conductive material such as metal or an insulating substrate using a glass material or the like can also be used. The substrate 10 may have any desired outer shape, such as a rectangular plate shape or a disk shape.

In this way, by converting the amorphous film 20 formed in a thin film on the substrate 10 into an electret, it is possible to obtain a high-performance electret 1 having a desired thin film shape according to the application, etc., and excellent thermal stability.

### EXAMPLES

### Examples 1 to 3

An electret 1 having the configuration shown in FIG. 1 is produced by the following method, and the electret performance is evaluated. The electret 1 is made by using a composite oxide in which the metal element A, in the composition formula A₃B₅O₁₂, is Y and the metal element B is Al, preparing a pellet-shaped polycrystalline body 2, and subjecting it to a polarization treatment to form an electret. In this case, Y₃Al₅O₁₂ (hereinafter referred to as YAO) not substituted with the dopant element D is designated as Example 1. Dopant-substituted YAO in which a part of the Y in the A site is substituted with 1 atm % Mg and 5 atm % Sr as the dopant element D, respectively, are designated as Examples 2 and 3 (Mg 1%: YAO, Sr 5%: YAO).

### <Preparation of Composite Oxide Powder>

As starting materials, powder reagents shown in Table 1 (raw material powders: Y₂O₃, Al₂O₃, MgO, SrO) were prepared and weighed. For each of Examples 1 to 3, raw material powders weighed out to obtain a predetermined composition were placed in a glass tube, and 30 g of grinding balls (ZrO₂; φ2 mm) and 30 ml of ethanol were added. The mixture was then ground and mixed using a ball mill at a rotation speed of 300 rpm for 24 hours. Thereafter, the solution, excluding the grinding balls, was transferred to a petri dish and dried for 24 hours. The powder obtained after drying was placed in an agate mortar and pulverized, and then placed in an alumina crucible and calcined. The calcination conditions were as follows: First, the temperature was raised to 1400° C. at a rate of 2° C./min, and then held at 1400° C. for 8 hours, and then lowered to room temperature at a rate of 2° C./min to obtain a calcined powder.

TABLE 1

| Example / | | | |
|---|---|---|---|
| raw material | | | |
| powder | Example 1 | Example 2 | Example 3 |
| Y₂O₃ | 5.71 g | 5.67 g | 5.43 g |
| Al₂O₃ | 4.29 g | 4.31 g | 4.31 g |
| MgO | — | 0.02 g | — |
| SrO | — | — | 0.26 g |

### <Preparation of Sintered Pellet (Polycrystalline Body 2)>

The calcined powder sample was placed in an agate mortar and pulverized, and further classified (<100 μm) to obtain a molding powder. About 0.55 g of the molding powder was placed in a pellet molding unit having a diameter of @13 mm and pressed at a pressure of 250 MPa for 3 minutes to form a disk-shaped pellet. The resulting molded pellets were then placed in an alumina crucible and sintered. The firing conditions were as follows: First, the temperature was raised to 1700° C. at a rate of 2.5° C./min, and was held at 1700° C. for 2 hours. Thereafter, the temperature was decreased to room temperature at a rate of 2.5° C./min. The sintered pellet thus obtained had an outer diameter of about @11 mm and a thickness of about 1.3 mm.

### <Polarization Treatment>

The polycrystalline bodies 2 of Examples 1 to 3 were each subjected to polarization treatment by the method shown in FIG. 1. The polycrystalline body 2 was sandwiched between a pair of insulating sheets 31 processed to a diameter of ¢11 mm, and brought into contact with a pair of electrodes (not shown) connected to a DC power source 100 of the polarization treatment device. The insulating sheet 31 used had an Au film 32 formed on the surface that came into contact with the electrode portion. The polarization tool, in which the polycrystalline body 2 was thus arranged between the pair of electrodes, was placed in a box furnace and left there until the temperature inside the furnace became stable at 200° C. Next, while the temperature was stabilized at 200° C., a DC electric field of 8.0 kV/mm was applied between the pair of electrodes, thereby carrying out a polarization treatment for 3 minutes. After the predetermined treatment time had elapsed, the sample was allowed to cool to 40° C. or lower while the DC electric field was still being applied.

### <Surface Potential Measurement>

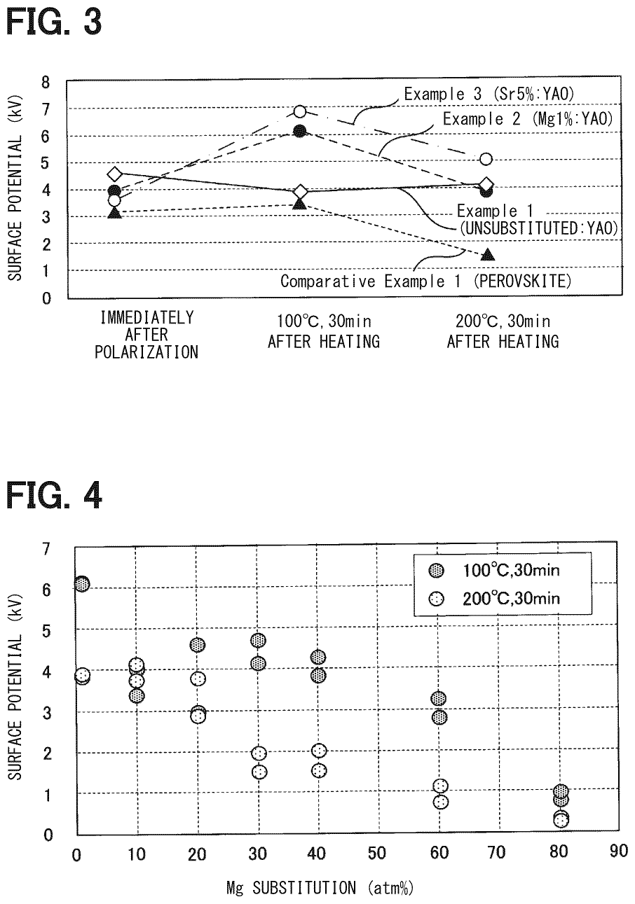

For each of the thus obtained electrets 1 of Examples 1 to 3, the surface potential immediately after the polarization treatment was measured. For the measurement, a surface potential was measured in a non-contact manner using a surface potential meter (MODEL 341-B, manufactured by Trek Japan Co., Ltd.). In addition, following the measurement immediately after the polarization treatment, the sample was heated in a drying furnace at 100° C. for 30 minutes and then at 200° C. for 30 minutes, after which the surface potential was measured and the influence of the thermal environment was evaluated. The results are shown in FIG. 3 immediately after polarization, after heating at 100° C. for 30 minutes, and after heating at 200° C. for 30 minutes.

### Comparative Example 1

For comparison, a composite oxide (YAlO₃) having a perovskite type composition containing the same metal elements as in Example 1 was used as a conventional electret material, and a polycrystalline body 2 was produced in the same manner using raw material powder weighed out to obtain a predetermined composition, and the polycrystalline body 2 was subjected to a polarization treatment to become an electret. The electret 1 of Comparative Example 1 thus obtained was measured for surface potential in the same manner as in Example 1 immediately after the polarization treatment (hereinafter, appropriately, immediately after the polarization treatment), after heating at 100° C. for 30 minutes (hereinafter, appropriately, after heating at 100° C.), and after heating at 200° C. for 30 minutes (hereinafter, appropriately, after heating at 200° C.). The results are shown in FIG. 3, in comparison with Examples 1 to 3.

As shown in FIG. 3, the electrets 1 of Examples 1 to 3 have a surface potential (absolute value) immediately after polarization in the range of 3.5 kV to over 4.5 kV, which is higher than the electret 1 of Comparative Example 1, which is over 3 kV. In addition, the tendency after heating differs depending on the presence or absence of the dopant element D, and the surface potential (absolute value) of the electret 1 (unsubstituted: YAO) in Example 1 is the highest value of over 4.5 kV immediately after polarization. After the heat treatment, the surface potential (absolute value) is slightly lowered but remains stable at around 4 kV, and after heating at 200° C., the value is actually higher than after heating at 100° C.

The surface potential (absolute value) of the electret 1 (Mg 1%: YAO) of Example 2 and the electret 1 (Sr 5%: YAO) of Example 3 immediately after polarization is in the range of about 3.5 kV to 4 kV, whereas after heating at 100° C., it improves to about 6 kV to 7 kV, which is nearly twice as high. After heating at 200° C., the potential drops below that after heating at 100° C., but remains at about 4 kV to 5 kV, which is equal to or higher than that immediately after polarization. In contrast, the surface potential (absolute value) of the electret 1 of Comparative Example 1 is somewhat high after heating at 100° C., but is significantly reduced after heating at 200° C., being reduced by half to about 1.5 kV.

These results show that the use of a composite oxide having a garnet-type composition improves the surface potential overall compared to a composite oxide having a perovskite-type composition, and is particularly effective in maintaining the surface potential after heating to 200° C. Moreover, since the material substituted with a dopant element exhibited a remarkable effect in improving the surface potential after heating at 100° C., it is presumed that oxygen defects introduced into the garnet-type composition contributed to this.

For the electrets 1 of Examples 1 to 3 and Comparative Example 1, the measured values (absolute values) of the surface potential are shown in Table 2 together with the band gap energy of the composite oxide which is the basic composition. As shown in Table 2, the composite oxides having a garnet-type composition in Examples 1 to 3 (YAO, dopant-substituted YAO) have a band gap energy of 4.49 eV, and the composite oxide having a perovskite-type composition in Comparative Example 1 (YAlO₃) has a band gap energy of 5.54 eV.

TABLE 2

| | | | | Gd3Al2 | YAlO3 |
|---|---|---|---|---|---|
| basic | | | | Ga3O12 | (Comparative |
| composition | | | | (Example 4) | Example 1) |
| | | | | 3.2 eV | 5.54 eV |
| band gap | Y3Al5O12 (Examples 1 to 3) | | | (estimated | |
| energy | 4.49 eV | | | value) | |
| dopant element | — | Mg: 1 atm % | Sr: 5 atm % | 3433 | 18 |
| surface potential | 4.58 kV | 3.92 kV | 3.57 kV | 3.72 kV | 3.16 kV |
| absolute value | | | | | |
| (immediately | | | | | |
| after polarization) | | | | | |
| surface potential | 3.86 kV | 6.11 kV | 6.88 kV | 5.21 kV | 3.41 kV |
| (100 ° C., 30 min | | | | | |
| after heating) | | | | | |
| surface potential | 4.08 kV | 3.86 kV | 5.06 kV | 2.72 kV | 1.46 kV |
| (200 ° C., 30 min | | | | | |
| after heating) | | | | | |

### (Test Sample 1)

For the electret 1 (Mg 1%: YAO) of Example 2, the substitution amount X of Mg, which is the dopant element D, was changed in the range of 10 atm % to 80 atm %, as shown in Table 3, to obtain Test Samples 1 to 7. Sample 1 has the same substitution amount X as the electret 1 in Example 2, and the raw material powder was weighed so that the Mg substitution amount of the electret 1 in Samples 2 to 7 are 10 atm %, 20 atm %, 30 atm %, 40 atm %, 60 atm %, and 80 atm %, respectively. Except for the above, the polycrystalline body 2 was prepared in the same manner as in Example 1, and was subjected to a polarization treatment to form an electret.

TABLE 3

| Sample | 1 | | 2 | | 3 | | 4 | | 5 | | 6 | | 7 | |
|---|---|---|---|---|---|---|---|---|---|---|---|---|---|---|
| Mg | 1 | atm % | 10 | atm % | 20 | atm % | 30 | atm % | 40 | atm % | 60 | atm % | 80 | atm % |
| substitution/ | | | | | | | | | | | | | | |
| raw material | | | | | | | | | | | | | | |
| powder | | | | | | | | | | | | | | |
| Y₂O₃ | 5.67 | g | 5.33 | g | 4.93 | g | 4.49 | g | 4.01 | g | 2.93 | g | 1.62 | g |
| Al₂O₃ | 4.31 | g | 4.46 | g | 4.63 | g | 4.83 | g | 5.03 | g | 5.50 | g | 6.08 | g |
| MgO | 0.02 | g | 0.21 | g | 0.44 | g | 0.69 | g | 0.96 | g | 1.57 | g | 2.30 | g |

As shown in Table 4, plural electrets (a, b) of each of Samples 1 to 7 were prepared, and the surface potential immediately after polarization was measured in the same manner as in Example 1. In addition, the surface potential was measured after heating at 100° C. for 30 minutes and then after heating at 200° C. for 30 minutes. The measurement results for Samples 1 (1a, 1b) to 7 (7a, 7b) are shown in Table 4, and the surface potentials (absolute values) are compared after heating at 100° C. and 200° C. in FIG. 4. The results of Sample 1a are the same as those of Example 2 shown in Table 2.

TABLE 4

| Sample | | 1 | 2 | 3 | 4 | 5 | 6 | 7 |
|---|---|---|---|---|---|---|---|---|
| Mg substitution/ | | 1 atm % | 10 atm % | 20 atm % | 30 atm % | 40 atm % | 60 atm % | 80 atm % |
| surface potential | | | | | | | | |
| (absolute value) | | | | | | | | |
| immediately | a | 3.92 | 2.70 | 2.28 | 4.20 | 2.89 | 3.50 | 1.65 |
| after | b | 3.88 | 1.66 | 2.27 | 4.29 | 3.38 | 3.18 | 1.63 |
| polarization | | | | | | | | |
| (kV) | | | | | | | | |
| 100° C., 30 min | a | 6.11 | 4.05 | 4.62 | 4.71 | 4.28 | 3.26 | 0.95 |
| after heating | b | 6.13 | 3.39 | 2.95 | 4.14 | 3.84 | 2.81 | 0.78 |
| (kV) | | | | | | | | |
| 200° C., 30 min | a | 3.86 | 4.15 | 3.81 | 1.98 | 1.53 | 1.14 | 0.32 |
| after heating | b | 3.91 | 3.75 | 2.87 | 1.52 | 2.01 | 0.74 | 0.25 |
| (kV) | | | | | | | | |

As shown in Table 4 and FIG. 4, the surface potential (absolute value) of the electrets 1 of Samples 2a, 2b to 6a, 6b after heating at 100° C. for 30 minutes is in the range of about 3 kV to 5 kV, which is lower than the value of Samples 1a, 1b exceeding 6 kV. However, all of them show values almost equal to or higher than those immediately after polarization. Samples 7a, 7b also showed a relatively high value of over 1.5 kV immediately after polarization, and about 1 KV even after heating at 100° C. for 30 minutes.

Moreover, the surface potential (absolute value) after heating at 200° C. for 30 minutes is maintained at a high value in the range of about 3 kV to more than 4 KV for the electret 1 of Samples 2a, 2b to 3a, 3b. In contrast, the electret 1 of Samples 4a, 4b to 6a, 6b are in the range of about 1 kV to 2 kV, and the electret 1 of Samples 7a, 7b are about 0.3 kV, and the surface potential (absolute value) tends to decrease as the Mg substitution amount increases.

From these results, when using a composite oxide substituted with a dopant element D, it is preferable to select the substitution amount X of the dopant element D so as to obtain a desired surface potential in the operating temperature environment, taking into consideration that the surface potential (absolute value) after heat treatment changes depending on the substitution amount X of the dopant element D. For example, by setting the substitution amount X in the range of 60 atm % or less, a high surface potential (absolute value) of about 1 kV or more can be obtained even at 200° C., and it is possible to achieve a high surface potential (absolute value) of about 1 KV or more when the substitution amount X is 40 atm % or less, and a high surface potential (absolute value) of about 3 kV or more when the substitution amount X is 20 atm % or less.

### Example 4

For the electret 1 having the configuration shown in FIG. 1, the electret performance was evaluated by using a composite oxide in which the metal elements A and B in the composition formula A₃B₅O₁₂ were changed. The composite oxide was an oxide (hereinafter referred to as GAGO) in which the metal element A is Gd and the metal element B is Al and Ga, and a portion of the Gd in the A site is substituted with 1 atm % Sr as the dopant element D to form a dopant-substituted GAGO (Sr 1%: GAGO).

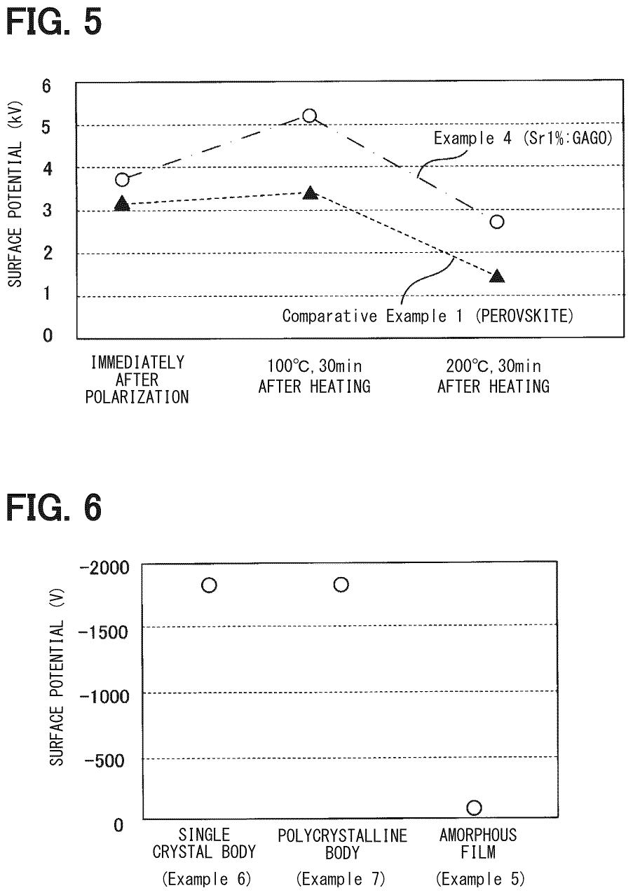

The electret 1 of Example 4 was prepared by weighing out the powder reagents (raw material powders: Ga₂O₃, Al₂O₃, Ga₂O₃, SrO) as starting materials to obtain the desired composition as shown in Table 5, and preparing a pellet-shaped polycrystalline body 2 in the same manner as in Example 1, and subjecting it to a polarization treatment to form an electret. The surface potential of the obtained electret 1 was measured immediately after polarization, after heating at 100° C. for 30 minutes, and after heating at 200° C. for 30 minutes in the same manner as in Example 1. The results are shown in FIG. 5. For comparison, the results of Comparative Example 1 are also shown in FIG. 5.

TABLE 5

| Example 4 / | |
|---|---|
| raw material | |
| powder | Sr 1%: GAGO |
| Gd₂O₃ | 5.82 g |
| Al₂O₃ | 1.10 g |
| Ga₂O₃ | 3.04 g |
| SrO | 0.03 g |

As shown in FIG. 5, the electret 1 (Sr 1%: GAGO) of Example 4 exhibits a high surface potential (absolute value) of more than 3.5 kV immediately after polarization, and after heating at 100° C. for 30 minutes, this is further improved to more than 5 kV. After heating at 200° C. for 30 minutes, the voltage is below 3 kV, but is about twice as high as that of the electret 1 having the perovskite composition of Comparative Example 1.

In this way, even when the metal element A occupying the A site is changed and plural elements (Al, Ga) are used as the metal element B occupying the B site, an electret 1 exhibiting equivalent electret performance can be obtained. From these results, it is presumed that it is important to use a composite oxide having a garnet-type composition, and that this contributes to the development of a surface potential in the electret 1 and the maintenance of the surface potential in a high-temperature environment.

For the electret 1 of Example 4, the measured values (absolute values) of the surface potential are shown in Table 2 together with the band gap energy of the composite oxide which is the basic composition. As shown in Table 2, the composite oxide (GAGO) having a garnet-type composition in Example 4 has a band gap energy (estimated value) of 3.2 eV. Therefore, it is understood that a composite oxide having a garnet-type composition and a band gap energy of 3 eV or more exhibits a desired high surface potential and is excellent in thermal stability.

### Examples 5 to 7

The electret performance was evaluated for the electret 1 having a garnet-type composition equivalent to that of the electret 1 (Mg 1%: YAO) of Example 2 but having a different form. First, as Example 5, the electret 1 having the configuration shown in FIG. 2 was produced by the following method. The electret 1 was prepared by forming an amorphous film 20 on a substrate 10 and subjecting it to polarization treatment by corona discharge. As the substrate 10, a conductive substrate (0.6 mm) made of SrTiO₃ containing 0.5 mass % Nb was prepared.

### <Film Formation>

A film containing Y, Mg, Al, and O was formed on the surface of the substrate 10 by sputtering using a polycrystalline material having a garnet-type composition [(Y_{0.99}Mg_{0.01})₃Al₅O₁₂] prepared in advance as a target under conditions of an Ar atmosphere and 360° C. The deposited film was amorphous and contained Y, Al, and O in a ratio of approximately 3:5:12, and had a thickness of 1 μm.

### <Polarization Treatment>

Next, the substrate 10 having the amorphous film 20 formed on its surface was placed on the surface of a grounded heater plate, and a polarization treatment was performed by corona discharge with the back side of the substrate 10 in contact with the heater plate. The heating temperature by the heater plate and the conditions of the corona discharge treatment were as follows. Corona discharge was performed by placing a discharge needle facing the surface of the amorphous film 20 serving as a sample.
Heating temperature: 200° C.
Discharge voltage: −5.5 kV
Discharge time: 3 minutes
Distance between discharge needle and sample: 10 mm

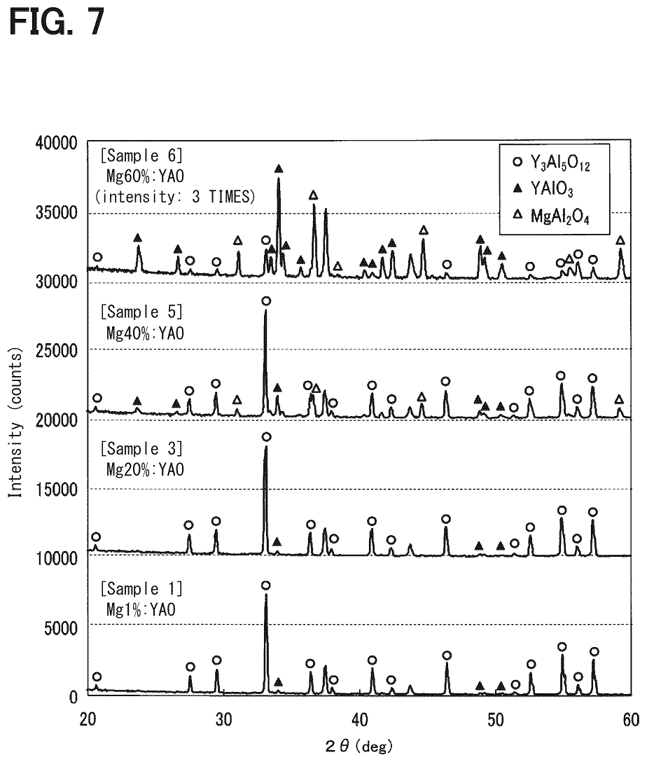

As the electret 1 of Example 6, a single crystal [(Y_{0.99}Mg_{0.01})₃Al₅O₁₂] having a garnet-type composition and measuring 10 mm square and 0.5 mm thick was prepared and subjected to the same polarization treatment to form an electret. Furthermore, a polycrystalline body 2 prepared in the same manner as in Example 2 was subjected to the same polarization treatment to be made into an electret, which was used as Example 7. The surface potential of each of the thus obtained electrets 1 of Examples 5 to 7 was measured in the same manner as in Example 1, and the results are shown in FIG. 6.

As shown in FIG. 6, the electret 1 of Examples 6 and 7 using crystalline oxides had surface potentials immediately after polarization of −1832 V (single crystal) and −1824 V (polycrystalline), respectively, which were almost equal high values. Also, the electret 1 of Example 5 using a non-crystalline oxide exhibited a surface potential of −103.5 V (amorphous) immediately after polarization. From these results, it is understood that by having a garnet-type composition, it is possible to form an electret regardless of the form of the composite oxide, and a practical electret 1 can be obtained.

In addition, in order to examine the influence of the amount of Mg substitution on the crystal structure of the electret 1 (Mg 1%: YAO) of Example 2, a structural analysis (XRD) was performed using an X-ray diffraction device, and the results are shown in FIG. 7. FIG. 7 shows the results of analysis by XRD for the electret 1 (Sample 1) of Example 2 and Samples used in Test Sample 1, in which the Mg substitution was 20 atm % (Sample 3), 40 atm % (Sample 5), and 60 atm % (Sample 6).

As shown in FIG. 7, among Samples used in Test Sample 1, the results of structural analysis (XRD) using an X-ray diffraction device were compared for Samples with Mg substitution amounts of 1 atm % (Sample 1), 20 atm % (Sample 3), 40 atm % (Sample 5), and 60 atm % (Sample 6). As a result, in Samples 1 and 3 in which the Mg substitution was 20 atm % or less, the composition was almost a garnet type (Y₃Al₅O₁₂), with only a slight peak due to the perovskite type composition (YAlO₃), whereas as the Mg substitution increased, a tendency for different compositions to increase was observed. For example, in Samples 5 and 6, in which the Mg substitution is 40 atm % or more, peaks based on the spinel type composition (MgAl₂O₄) are observed, and in Sample 6, in which the Mg substitution is 60 atm %, the peak based on the perovskite type or spinel type composition becomes larger.

In the results shown in FIG. 4, when the amount of Mg substitution exceeded 40 atm %, the surface potential (absolute value) after heating tended to decrease, which is presumably due to an increase in crystals other than the garnet type. Furthermore, when the Mg substitution was 20 atm % or less, a stable surface potential was maintained even after heat treatment at 200° C., which indicates that the thermal stability is improved by increasing the amount of crystals with a garnet-type composition. It has been confirmed that the same tendency is observed when the dopant element is Sr.

In this way, by using a crystalline or non-crystalline oxide that is a complex oxide having a garnet-type composition and has a band gap energy of 3 eV or more, the thermal stability of the electret 1 can be improved. Therefore, when producing the electret 1, it is possible to produce a highly practical electret 1 by appropriately selecting a form such as a single crystal, a polycrystalline body, or an amorphous film depending on, for example, the usage environment and the required shape or performance.

Although the present disclosure is described based on the above embodiments, the present disclosure is not limited to the embodiments and the structures. The present disclosure encompasses various modifications and variations within the scope of equivalents. In addition, various combinations and forms, as well as other combinations or forms including more, less, or only a single element, also fall within the scope and spirit of the present disclosure.

The present disclosure is not limited to the respective embodiments described above, and various modifications may be adopted within the scope of the present disclosure without departing from the spirit of the disclosure.

What is claimed is:

1. An electret obtained by subjecting a composite oxide containing two or more metal elements to a polarization treatment, wherein
the composite oxide is a crystalline or non-crystalline oxide containing two different trivalent metal elements A and B, having a basic composition represented by composition formula A₃B₅O₁₂, and having a band gap energy of 3 eV or more.

2. The electret according to claim 1, wherein the metal element A includes at least one element selected from trivalent rare earth elements, and the metal element B includes at least one element selected from trivalent typical elements.

3. The electret according to claim 1, wherein the metal element A is at least one element selected from La, Y, Sm, and Gd, and the metal element B is at least one element selected from Al and Ga.

4. The electret according to claim 1, wherein at least one of the metal elements A or B is partially substituted with a dopant element D having a lower valence than the metal elements A or B.

5. The electret according to claim 4, wherein a substitution amount X of the metal elements A or B by the dopant element is 60 atm % or less when a total amount of the metal elements A and B is 100 atm %.

6. The electret according to claim 5, wherein the metal element A is partially substituted with the dopant element selected from alkaline earth metal elements, and a substitution amount X1 of the metal element A by the dopant element is in a range of 0 atm %<X1≤60 atm %.

7. The electret according to claim 6, wherein the substitution amount X1 of the metal element A by the dopant element is in a range of 0 atm %<X1≤40 atm %.

8. The electret according to claim 5, wherein the metal element B is partially substituted with the dopant element selected from an alkaline earth metal element and Zn, and a substitution amount X2 of the metal element B by the dopant element is in a range of 0 atm %<X2≤60 atm %.

9. The electret according to claim 8, wherein a substitution amount X2 of the metal element B by the dopant element is in a range of 0 atm %<X2≤40 atm %.

10. The electret according to claim 1, wherein the composite oxide is in form of a single crystal, a polycrystal, or an amorphous film.
